(19) United States
(12) Patent Application Publication
(10) Pub. No.: US 2025/0229650 A1
(43) Pub. Date: Jul. 17, 2025

(54) Electrically Operated Vehicle

(71) Applicant: H2 Power 'n' Heat GmbH, Potsdam (DE)

(72) Inventor: Christoph Fiala, Potsdam (DE)

(21) Appl. No.: 18/855,305

(22) PCT Filed: Mar. 16, 2023
(86) PCT No.: PCT/EP2023/056716

§ 371 Date: Oct. 8, 2024

(30) Foreign Application Priority Data
Apr. 8, 2022 (DE) 10 2022 108 595.3
Oct. 13, 2022 (DE) 10 2022 126 767.9

(51) Int. Cl. B60L 50/75; B60H 1/00; B60H 1/22; B60K 15/03; B60K 15/067; B60L 53/54; B60L 53/62; B60L 58/15; B60L 58/34; B60L 58/40; H01M 8/04082; H01M 8/0432; H01M 8/04537; H01M 10/46; H01M 16/00

(52) U.S. Cl. CPC B60L 50/75; B60H 1/00392; B60H 1/2215; B60K 15/067; B60L 53/54; B60L 53/62; B60L 58/15; B60L 58/34; B60L 58/40; H01M 8/04201; H01M 8/04373; H01M 8/04626; H01M 10/46; H01M 16/006; B60K 2015/03315; H01M 2220/20; H01M 2250/20; H01M 2250/402

(57) ABSTRACT

The invention relates to an electrically operated vehicle containing an electrically rechargeable vehicle battery for supplying an electric drive for moving the vehicle; a tank for receiving a liquid or gaseous fuel; and a fuel cell which is operated using fuel from the tank for heating a passenger compartment, vehicle components, and/or the battery of the vehicle. The invention is characterized in that the tank and the fuel cell form modules with which the vehicle is retrofitted.

### TECHNICAL FIELD

The invention relates to an electrically operated vehicle comprising
(a) an electrically rechargeable vehicle battery for powering an electrical drive for moving the vehicle;
(b) a tank for storing liquid or gaseous fuel; and
(c) a fuel cell operated with fuel from said tank for heating the passenger cabin, vehicle components and/or vehicle battery of said vehicle.

A vehicle can be moved on land, in water or in the air. In particular, a vehicle can be a passenger car, truck, mobile home, sailboat, ship, airplane, motorcycle and the like.

In the past, most vehicles were powered by fossil fuels, for example in a combustion engine. Other solutions are now being sought to achieve climate neutrality. In particular, vehicles with electric drives and a powerful vehicle battery are already available as standard. Drives with fuel cells are also known.

In combustion engines, energy which is chemically stored in fuel is first converted into thermal energy and then into mechanical work. In electric vehicles, the energy stored in a battery is converted into mechanical work via an electric drive. In a fuel cell, the energy stored chemically in a fuel, such as hydrogen, is converted directly into electrical energy and then into mechanical work.

In addition to these drive types, mixed forms, also known as hybrid drives, are known. These use a conventional combustion engine and an additional electric drive with a battery as an energy storage device. As long as the battery supplies energy, the vehicle is powered exclusively by electrical energy. After that, the combustion engine is used as the main drive. Depending on the design, the battery can be charged by recuperation or, in the case of plug-in hybrids, from external energy sources. Hybrid drives use two main drives and two associated energy storage devices-battery and fuel tank. These are complex and heavy, thereby increasing production costs, maintenance effort and energy requirements.

The disadvantages of purely electrically powered vehicles are the limited range, the long charging time and the short lifespan of the batteries. These adverse effects are more pronounced at low temperatures, i.e, particularly in cold regions, at night and in winter. At low temperatures, the efficiency of the battery drops. This makes it necessary to heat the battery. The heating is powered by energy from the vehicle battery. This also applies to the passenger cabin. This also has to be heated electrically to warm it up. This affects the range of the vehicle.

### PRIOR ART

DE102009035471A1 discloses a vehicle with a temperature control device for controlling the temperature of a vehicle battery in a vehicle in which a heat engine or fuel cell is provided as the main drive and the vehicle battery is provided for operating auxiliary units.

DE102011079640A1 discloses a cooling system for a fuel cell system with heat extraction. The system comprises a stationary energy supply system with a fuel cell system with a fuel cell cooling circuit for cooling the fuel cell system and an accumulator cooling circuit for cooling an accumulator. The thermal energy between the fuel cell cooling circuit and the accumulator cooling circuit is interchangeable.

DE102014009772A1 discloses an electric vehicle with a fuel cell system. The fuel cell system is provided for recharging the electrical energy storage device.

DE102017006158A1 discloses a method for operating an electric vehicle with a range extension by emptying an energy source before energy is taken up again.

DE102011076737A1 discloses a device for providing electrical energy, in which the electrical energy storage device is thermally coupled to the fuel cell assembly by means of a heat transfer assembly. The known fuel cell assembly is permanently installed in the vehicle. The associated additional costs and the additional weight therefore arise even when they are not needed at all, for example if the vehicle is to be used in warmer climates or only in summer, or if the vehicle is regularly parked in a garage where additional heating of the battery is not necessary.

### DISCLOSURE OF THE INVENTION

It is an object of the invention, to provide an electrically powered vehicle of the above mentioned kind, which enables a long range even at low temperatures. It is also an object of the invention to create further possible uses for fuel cells.

According to the present invention this object is achieved in that the tank and the fuel cell form modules with which the vehicle is retrofitted. Vehicles where there is no need for additional heating of the battery, for example because the vehicle is only used at higher temperatures, can then drive without a fuel cell and tank. This saves costs and weight, which means a longer range can be achieved. Vehicles that are also to be used at low temperatures can be retrofitted with the modules. The retrofitting of the otherwise unchanged vehicle can be done permanently or temporarily, for example for the cold season. Retrofitting with modules enables the production of identical vehicles for both applications—with and without a fuel cell—and thus in higher quantities. A higher number of units has a positive effect on production costs. In addition to the passenger cabin and vehicle battery, vehicle components, in particular electrical components such as the motor, inverter, etc., can also be heated.

A particular advantage of the modules is that they are also available for other uses independent of the vehicle. The modules can be used as a heating and power generator combination for mobile applications in camping, for emergency supplies, in emergency shelters, at events and the like.

It is particularly advantageous, if the tank forms a separate module and is releasably accommodated in the vehicle or in the module. Then the tank does not have to be filled separately. Instead, the tank can be replaced as a whole, similar to cartridges in a soda maker. For example, a deposit system can be set up for this or existing pressure tank systems can be used.

The fuel cell serves primarily as a heat source. High efficiency is achieved if the electrical power generated during operation is used. This can be done directly by connecting electrical consumers. In an advantageous embodiment of the invention, however, it is provided that the fuel cell is connected to the vehicle battery and in operation electrical energy can be fed to the vehicle battery. Then only one connection is required and the electrical consumers are supplied in the usual way via the on-board network.

In an advantageous embodiment it is provided that the fuel tank is a hydrogen tank and the fuel cell is operated with hydrogen. It is understood, however, that other fuel cell technologies are also possible.

A control unit may be provided for controlling the fuel cell which operates the fuel cell at least partially depending on a temperature value. The fuel cell may then be operated whenever the temperature of the energy storage unit of the vehicle's main drive falls below a threshold. It can also be operated when, for example, the passenger cabin needs to be heated.

A method for operating a fuel cell can comprise the steps:
(a) determining a temperature value;
(b) regulating the temperature value by generating thermal energy with the fuel cell to a set value; wherein
(c) electrical energy which is generated during operation of the fuel cell is stored or used for an electrical consumer.

The temperature value can represent the temperature in the passenger cabin of a vehicle, downstream of the vehicle heating or a vehicle battery. However, other temperature values, such as in the cargo area, can also be regulated to a set value.

Advantageously, the electrical energy is stored in a vehicle battery which is provided for driving a vehicle. This can extend the range. Thereby, the driving range can be extended. Alternatively or additionally, the electrical energy can be fed into the on-board network of a vehicle with one or more electrical consumers. This is particularly useful if a consumer requires electrical energy on a permanent basis, for example if an electrical consumer is a cooling unit. Energy losses and signs of aging in the battery due to intermediate storage are thus minimized.

The object of the present invention is also achieved by an auxiliary unit for retrofitting a vehicle with an additional energy source, containing
(a) a tank for storing a liquid or gaseous fuel;
(b) a fuel cell for generating thermal and electrical energy;
(c) a control unit for controlling the operation of the fuel cell depending on a temperature and/or the charge state of the battery.

Such an auxiliary unit can be installed in any series vehicle. It is installed as required, i.e. the costs and effort only arise if the vehicle is to be driven at low temperatures and a long range is desired. However, the auxiliary unit can also be used for other purposes. It is particularly advantageous if the tank is releasably connected to the module. The tank can then either be refilled, for example when installed, or replaced by a full tank.

Advantageously, it is provided that the tank, the fuel cell and the control unit are arranged in a jointly mountable module which has interfaces where the module can be connected to the respective functional units of the vehicle. The module can then also be installed and removed by automotive mechatronics engineers and other specialists who are not familiar with fuel technology. It is sufficient if they know which interfaces the module is connected to in the vehicle.

Further modifications of the invention are subject matter of the subclaims. An embodiment is described below in greater detail with reference to the accompanying drawings.

### Definitions

In this description and in the accompanying claims all terms have the meaning well known to the person skilled in the art which is defined in technical literature, norms and the relevant internet sites and publications, in particular of the lexical kind, such as www.wikipedia.de, www.wissen.de or www.techniklexikon.net, of competitors, research institutes, universities and associations. In particular, the terms used here have not the opposite meaning of what the person skilled in the art will derive from the above publications.

### BRIEF DESCRIPTION OF THE DRAWINGS

FIG. 1 is a schematic representation of a vehicle to illustrate the installation variants of a fuel cell module.

FIG. 2 is a perspective representation of a fuel cell module with housing and pressure tanks for hydrogen.

FIG. 3 shows the assembly of FIG. 2 with support structure without housing.

FIG. 4 shows the assembly of FIG. 3 without support structure.

FIG. 5 shows the assembly of FIG. 4 from a different perspective.

FIG. 6 is a side view of the assembly of FIG. 5 without pressure tank.

FIG. 7 is a top view of the assembly of FIG. 6.

FIG. 8 is a side view of the assembly of FIG. 6.

FIG. 9 shows a part of the assembly of FIG. 6 with water/coolant/power connections on the underside of the support structure.

FIG. 10 shows the assembly of FIG. 6 on a base in use as a stationary fuel cell for providing electrical energy.

FIG. 11 is a perspective representation of the base of FIG. 10 without housing.

FIG. 12 shows the assembly of FIG. 11 from a different perspective.

FIG. 13 is a side view of the base of FIG. 11.

FIG. 14 is a schematic representation of the circuits for the mobile application of the assembly of FIG. 2.

FIG. 15 is a schematic representation of the cathode subsystem of FIG. 14.

FIG. 16 is a schematic representation of the anode subsystem of FIG. 14.

FIG. 17 is a schematic representation of the cooling circuit subsystem.

FIG. 18 is a variant of FIG. 14 with its own cooling unit if the heat is not only taken away by the vehicle.

FIG. 19 is another variation of FIG. 14 with two separate heat exchangers for, for example, a battery and the cabin.

FIG. 20 is a schematic representation of the circuits for the stationary application of the assembly of FIG. 10.

### DESCRIPTION OF THE EMBODIMENTS

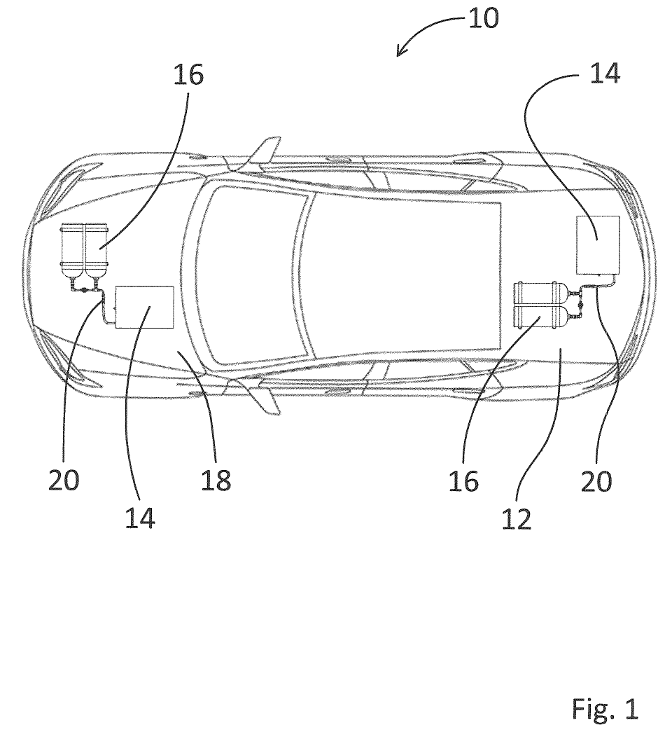

FIG. 1 shows a vehicle generally designated by numeral 10. In the present embodiment, the vehicle 10 is a passenger vehicle. It is understood that the invention can also be used for any other vehicle, i.e. trucks, mobile homes, sailing boats, ships, airplanes, motorcycles and the like. The vehicle has a cavity at the front or rear, such as a trunk 12 or 18. A fuel cell module 14 can be installed in the trunk 12 or 18. The fuel cell module 14 is supplied with hydrogen from a tank 16 via a supply line 20.

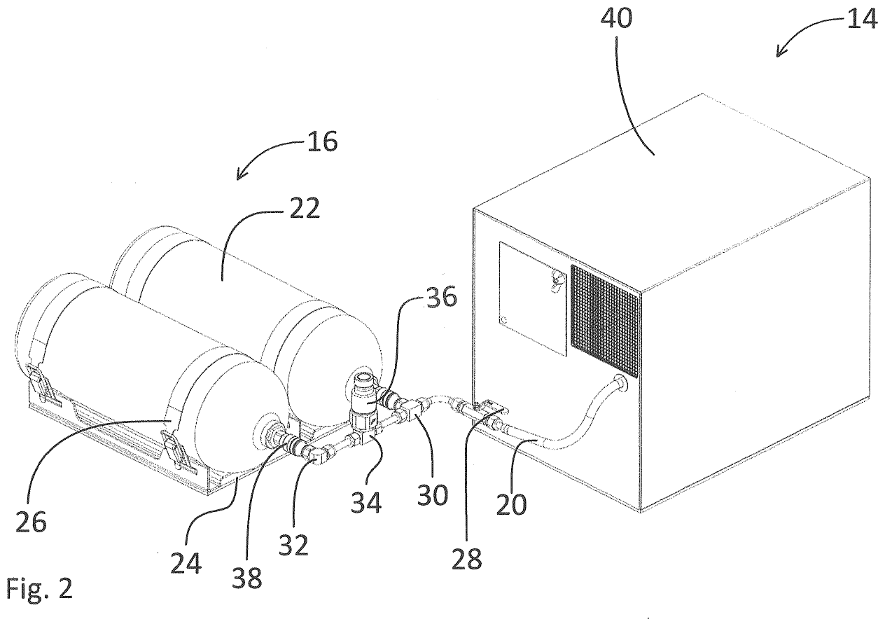

FIG. 2 shows the fuel cell module 14 and the tank 16 in detail. In the present embodiment, the tank 16 comprises two pressure tanks 22 with a volume of, for example, 6 l each and, for example, 350 bar or 700 bar, which are filled with liquid hydrogen. Depending on the fuel cell, other gases or liquids can of course also be used in more or fewer pressure tanks 22.

The pressure tanks 22 are bottle-shaped and are secured in a crash-proof manner to a common base plate 24. Tension belts 26 are provided for this purpose. It understood that other crash-proof fastenings are also possible instead of tension belts. The base plate 24 can be firmly screwed into the vehicle or fixed in any other way before the pressure tanks 22 are attached. This makes it easier to install the base plate 24. The tension belts 26 can also be operated by laypersons, so that the pressure tanks 22 can be easily released and replaced, maintained and/or filled if necessary.

The supply line 20 to the fuel cell module 14 is provided with a manually operated shut-off valve 28 on the module side. It is, however, understood that instead of a manually operated shut-off valve, automatically closing shut-off valves are also possible. Upstream of the shut-off valve 28, T-pieces 30 and 34 or a corner piece 32 are installed in the supply line 20. A first pressure tank 22 is connected via the T-piece 30. It is understood that further pressure tanks can also be connected via further T-pieces. Another pressure tank is connected to the corner piece 32. If only one pressure tank 22 is provided, no T-piece 30 is required. It is understood that a linear connection is also possible instead of a corner piece 32.

A filling connection 36 with a valve that opens in the direction of the supply line is connected to the T-piece 34. The pressure tanks 22 can be filled and refilled via the filling connection 36 when the shut-off valve 28 is closed. Instead of filling the pressure tanks 22 via the filling connection 36, empty pressure tanks 22 can also be replaced with full pressure tanks. In order to do this, a quick connector 38 is opened and the tension belts 26 are released. The quick connector 38 can, for example, be designed in a similar way to commercially available quick connectors for hoses from garden technology, where the opening in the pressure tank 22 is closed by a valve as soon as the quick connector 38 is released. It is, however, understood that any other connection can also be used.

The use of interchangeable pressure tanks 22 enables the use of a deposit system, so that not every gas station has to provide the required fuel at a pump. In an alternative embodiment, the tank 16 is firmly integrated into the fuel cell module 14 and housed together with it. Then only a nozzle for filling is accessible from the outside. The fuel cell module 14 is then somewhat larger, but easier to install.

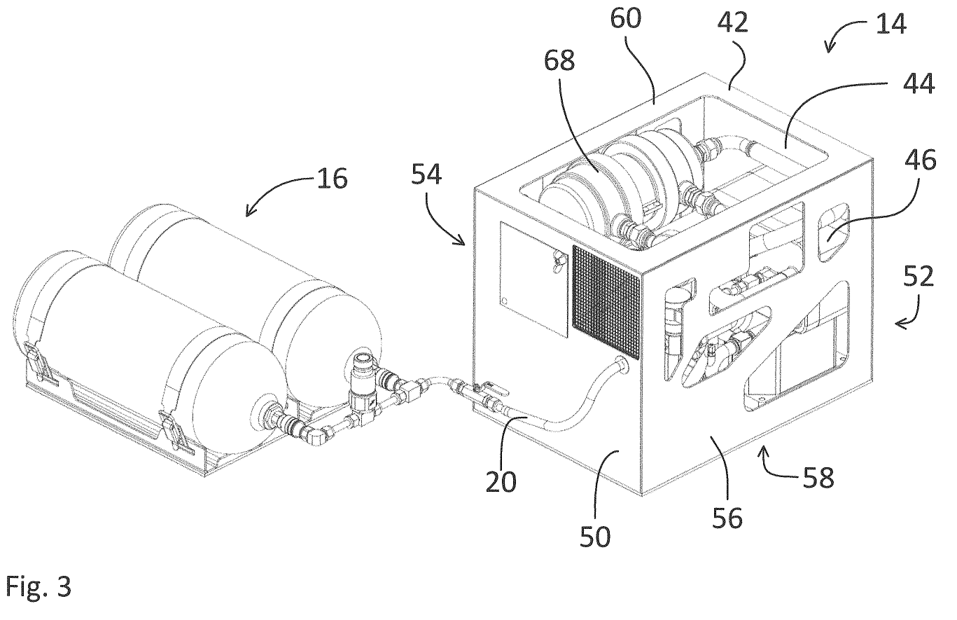

FIG. 2 shows the fuel cell module 14 with a simple housing 40 made of thin sheet metal. The housing 40 serves to protect against environmental influences, dust and unauthorized access. FIG. 3 shows the assembly from FIG. 2 without the housing 40. A support structure 42 can be seen on which the housing 40 is held. The support structure 42 comprises a front 50, a back 52, side walls 54 and 56, a base 58 and a top 60. The side walls 54 and 56 and the base 58 of the support structure 42 are made of a solid material, for example 4 mm thick steel, in order to avoid damage to the components inside as far as possible even in the event of an accident.

The interior of the essentially cuboid-shaped support structure 42 is easily accessible via an opening 44 in the top 60 and several openings 46 in the side walls 54 and 56. The components of the fuel cell module 14 described below are attached to this support structure 42. The openings 44, 46 allow access to the interior and also reduce the weight of the fuel cell module 14. In addition, less material is required for the support structure 42. This reduces costs.

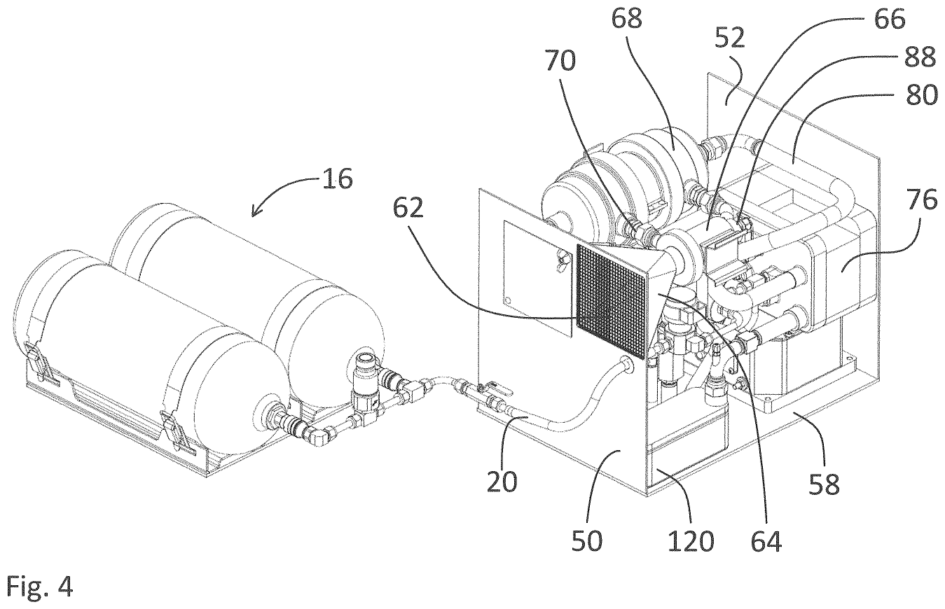

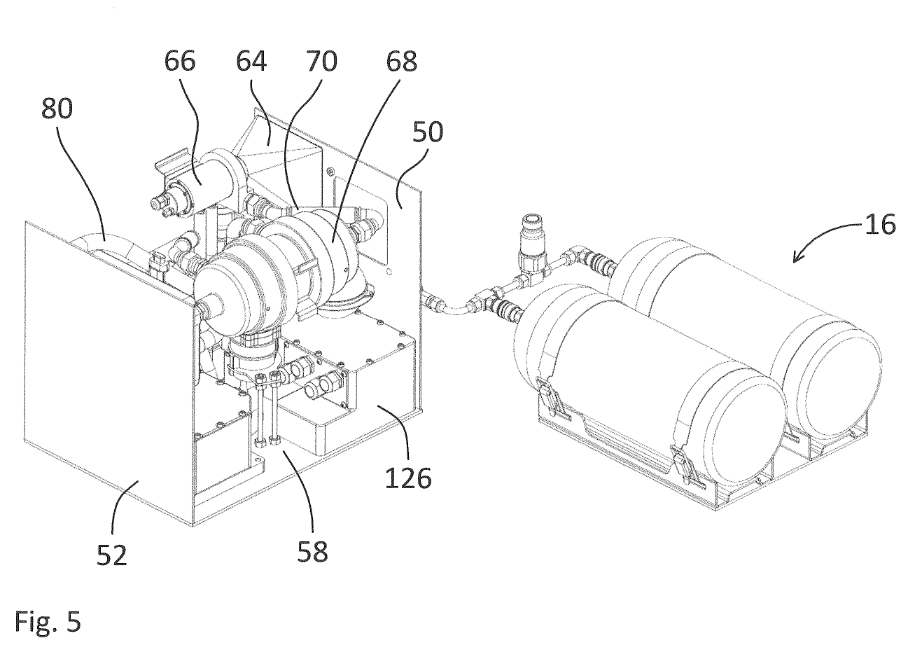

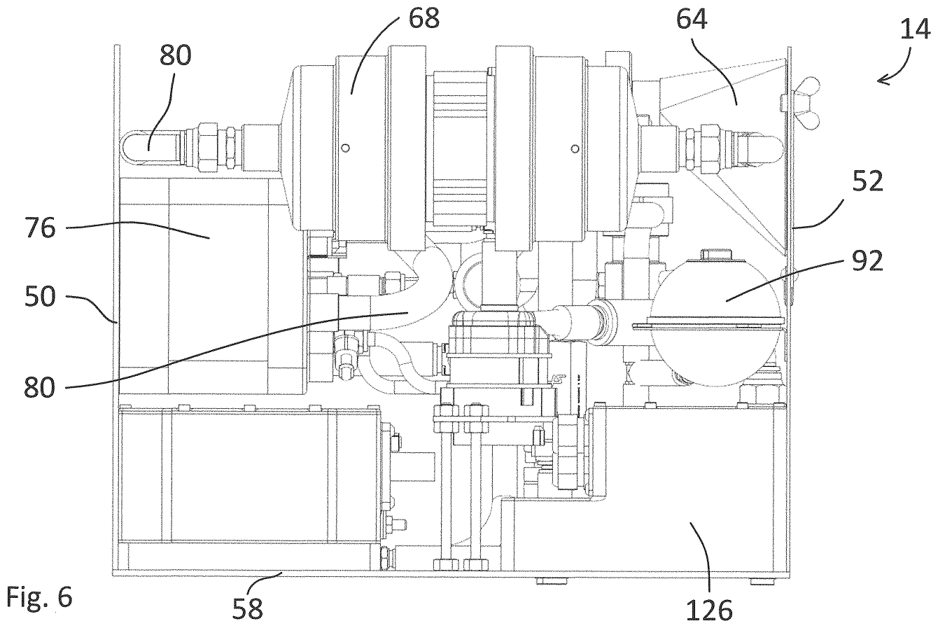

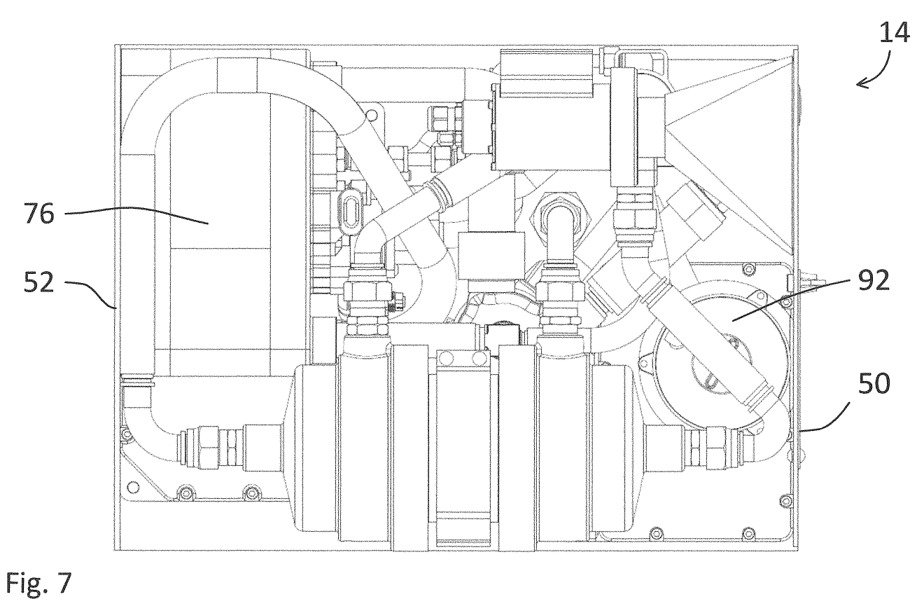

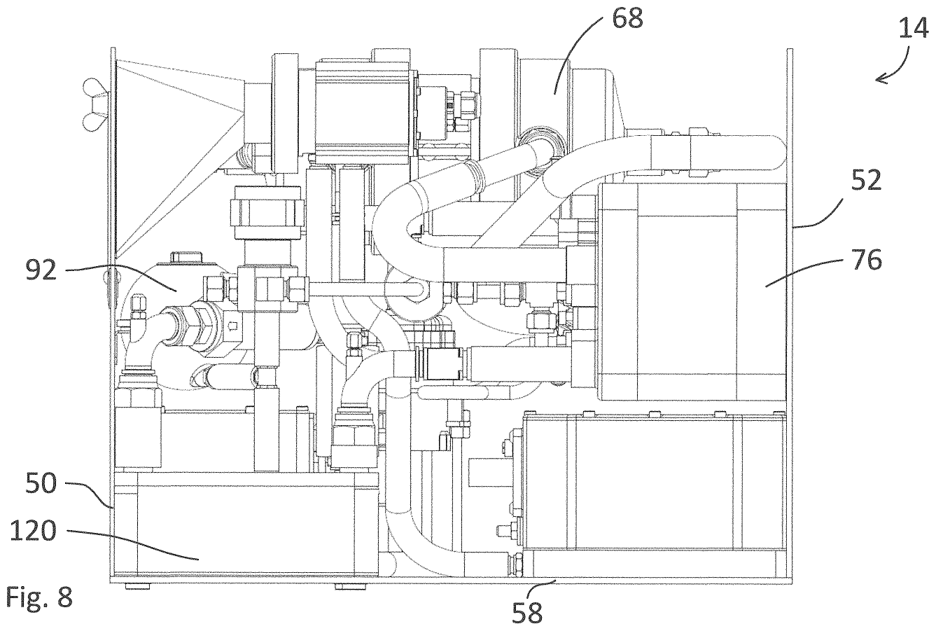

FIG. 4 shows the fuel cell module 14 without side walls 54 and 56 and without top 60 from a first perspective in which the front 50 is completely visible. FIG. 5 shows the same fuel cell module 14 from a second perspective in which the back 52 is completely visible.

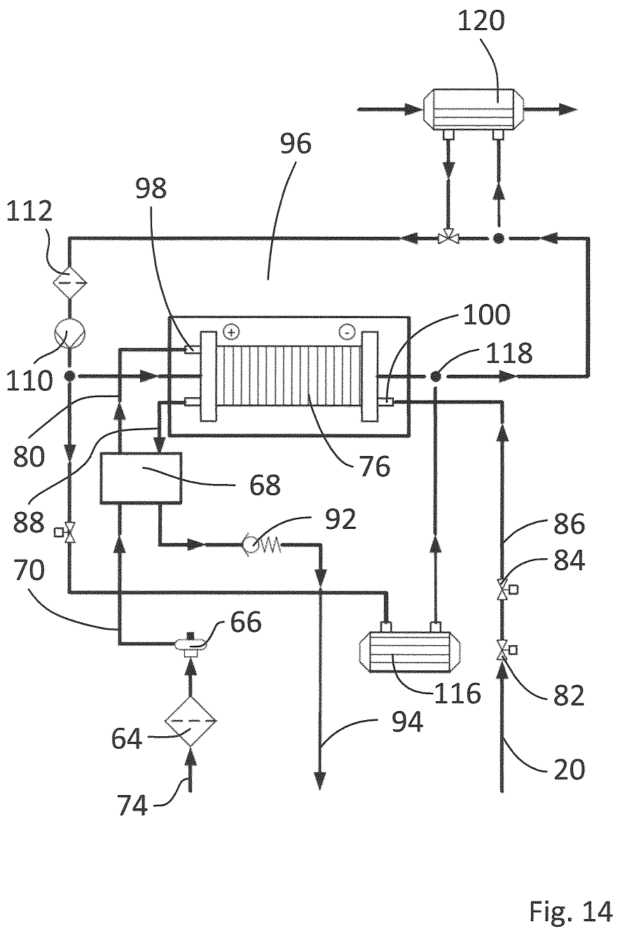

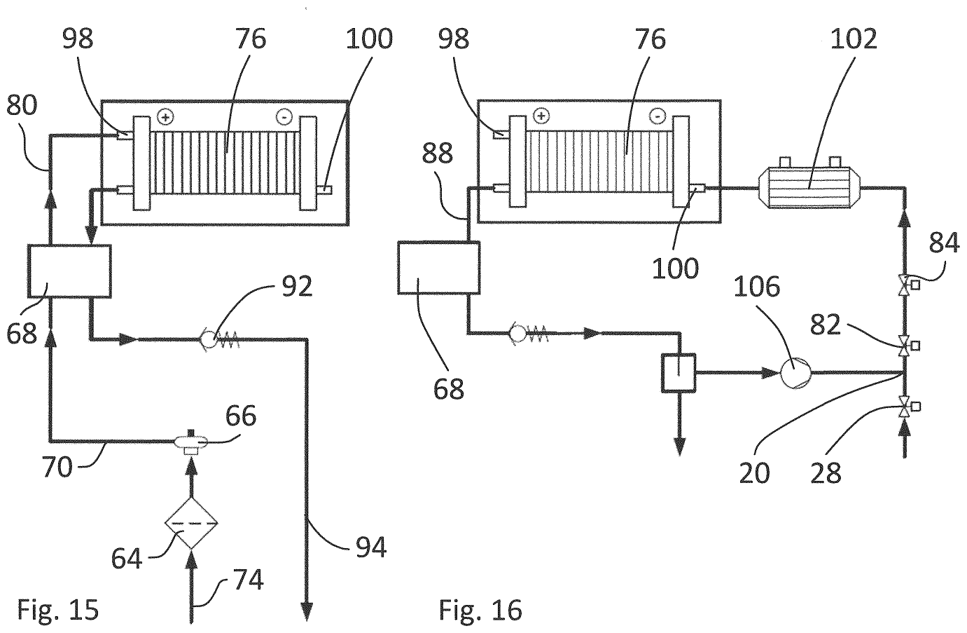

It can be seen in FIG. 4 that the front 50 has an opening 62 provided with a grid. Air is sucked in from outside through the opening 62. This is illustrated in FIG. 14 by an arrow 74. The air flows through a filter and a funnel 64 into a compressor or blower 66. This is illustrated in FIG. 14 and FIG. 15 by an arrow 74. In the compressor or blower 66, the air is compressed from the ambient pressure in the range of 1 bar to a higher pressure of, for example, 1.3 bar and transported into the fuel cell.

The output of the compressor or blower 66 is connected to a humidifier 68 via a connecting line 70. The water content of the air is increased in the humidifier 68. The air is fed from the humidifier 68 to the fuel cell 76 via a line 80. The fuel cell is attached to the rear wall 52 of the support structure 42 and can be clearly seen in FIG. 4. An increase in the air pressure and thus the amount of oxygen at the cathode 98 of the fuel cell 76 has a positive effect on the performance of the fuel cell 76, but at the same time requires more drive power at the compressor 66. The compressor 66 is the largest consumer of all components in the fuel cell module 14. The operating strategy is therefore crucial for a good overall efficiency of the fuel cell module 14. The cathode circuit is illustrated separately in FIG. 15.

Also on the front side 50 is the inlet for the fuel supply, in the present embodiment hydrogen, through the supply line 20. Behind the front side 50 there is a high-pressure valve 82 and a low-pressure valve 84 in the line 20. The high-pressure valve 82 reduces the pressure of the fuel from the tank 16 from, for example, 700 bar or 350 bar to a lower pressure of, for example, 10 bar. The subsequent, adjustable low-pressure valve 84 regulates the pressure of the fuel to the required operating pressure of the fuel cell 76, for example between 1 and 2.5 bar. The low-pressure valve 84 thus regulates the pressure to the operating pressure of the anode circuit. In order to avoid damage to the membrane of the fuel cell 76, the pressure difference between the anode 100 and the cathode 98 is as small as possible. An optional heat exchanger 102 is used to adapt the gas temperature to the fuel cell temperature.

The fuel is fed to the anode of the fuel cell 76 via a feed line 86. The hydrogen path (anode subsystem) described in this way is illustrated separately again in FIG. 16. It provides the required amount of hydrogen in the correct concentration, at the correct pressure and at the correct temperature to the fuel cell 76 for the electrochemical reaction.

In the fuel cell 76, the fuel reacts with the oxygen contained in the air. The operation of fuel cells is generally known in the art and therefore does not need to be explained here in greater detail. In principle, any fuel cell is suitable. In the present embodiment, the fuel is molecular hydrogen and the fuel cell is a low-temperature polymer electrolyte fuel cell, also known as NT-PEM-FC. The reaction produces heat and water. A voltage is also generated at the electrodes.

In order to prevent a hydrogen shortage, more hydrogen is usually supplied to the anode 100 than the reaction consumes. The excess hydrogen can be recirculated, with excess water in the hydrogen being separated after the anode 100 using a water separator 102. An actively controlled recirculation pump 106 optionally closes the circuit and leads the hydrogen mixture to the fresh hydrogen supply line 104. The optional recirculation enables better flow through the fuel cell 76, improves water management and reduces losses.

The water generated in the fuel cell 76 is fed via a line 88 to the humidifier 68. There it is used to humidify the air entering the assembly. Behind the humidifier, the gas is released to the outside as exhaust gas via a check valve 92. The check valve can also be designed as a siphon. This is illustrated in FIG. 14 by an arrow 94.

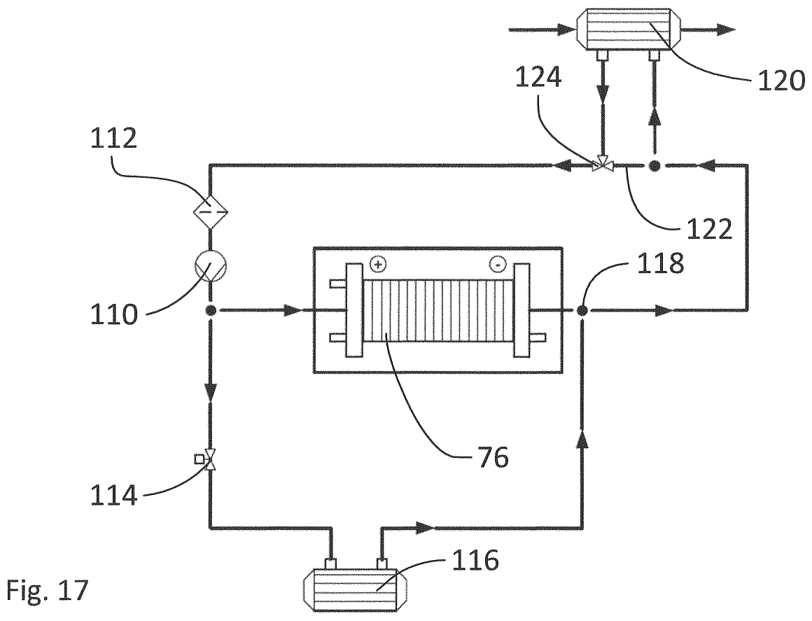

When the fuel cell 76 is operating, heat is generated. The heat is dissipated via a cooling circuit generally designated by numeral 96. The cooling circuit 96 is illustrated separately again in FIG. 17. The present fuel cell 76 achieves electrical efficiencies of up to 40%, depending on the quality of the hydrogen. This means that up to 60% of the energy supplied is generated as heat during operation. The heat output is therefore in a similar range to the useful electrical output. The operating temperature is relatively low and is in the range of 60 to 85° C. For this reason, the exhaust gas enthalpy is low and the exhaust gas enthalpy flow reaches a share of 5-15%.

The electrical output of the fuel cell system results from the output of the fuel cell stack minus the output for the components. The electrical efficiency results from the effective output described above, the mass flow of the hydrogen and its calorific value:

$${μ}_{el} = \frac{{P}_{eff}}{{\dot{m}}_{{H}_{2} \cdot Δ {H}_{{H}_{2}}}}$$

In general, the relationship is that the greatest effective efficiency is achieved at low current densities. At high current densities, the electrical efficiency decreases due to the increasing power requirements of the components and the decreasing fuel cell efficiency. The thermal power is also determined from the power of the fuel cell stack, the fuel energy supplied and the exhaust gas enthalpy flow. The following relationship results for the thermal efficiency:

$${μ}_{th} = 1 - ( {μ}_{Abgas} + {μ}_{el} ) = 1 - ( \frac{{P}_{eff}}{{\dot{m}}_{Abgas \cdot Δ {H}_{Abgas}}} + \frac{{P}_{eff}}{{\dot{m}}_{{H}_{2} \cdot Δ {H}_{{H}_{2}}}} )$$

In relation to the hydrogen used, the overall efficiency of the fuel cell module 14 increases with the utilization of the heat. In winter operation, this can achieve an overall efficiency of over 90%. The heat output can be used in mobile applications as heating for the vehicle interior and as a heat source for the thermal management system of the vehicle battery at operating temperature.

The heat from the fuel cell 76 is absorbed and dissipated via the cooling circuit 96. The design of the thermal management required for this depends not only on the connection to the fuel cell 76 but also on the auxiliary units used and the integration into the vehicle. The main task of thermal management is to monitor the temperature of the components, regulate the optimal temperature range and ensure rapid start-up after a standstill. FIG. 14 and FIG. 17 show the required components and their connections.

The coolant is fed through a filter 112 to a coolant pump 110. This pumps the coolant through the fuel cell 76, where the reaction heat is absorbed. Part of the coolant is fed via a throttle valve 114 to electronic components 116 in the vehicle, which are to be cooled and where heat is also absorbed. The warm coolant flows are brought together again at a T-piece 118. The warm coolant can be conveyed from there to the vehicle battery 120 and/or into the passenger cabin. The heat is released there. If no heating is necessary, the coolant can be passed through a bypass 122. A bypass valve 124 is provided for this purpose. The bypass valve 124 deactivates the thermal coupling in order to prevent any excess heat from being introduced into the vehicle, for example because the fuel cell takes too long to shut down.

By controlling a coolant pump 110 and by controlling the various valves, the optimal temperature range for the fuel cell module 14 is regulated. The 3-way valve 124 ideally distributes the heat flow to a cooler or a heat exchanger for heating the vehicle battery 120 or the vehicle interior. The cooling medium must be electrically insulating because it is in direct contact with the conductive bipolar plates. This can be achieved, for example, by using deionized coolants.

An integrated control unit 126 on the bottom of the support structure 42 controls, regulates and monitors operation. It includes the various operating modes, such as the start-up process, the three operating points, and the shutdown process. The controller 126 communicates with the vehicle control unit. In particular, signals relating to the temperature and battery status of the vehicle are read out at the control unit diagnostic interface. The control unit 126 is specifically supplied with signals via signal lines that represent the temperature of the battery 120, the passenger cabin, and the fuel cell 76. The control unit 126 is also supplied with signals that represent the charge status of the battery 120. The fuel cell module 14 can replace the heater that is otherwise installed as standard. However, the measuring points remain the same. If a temperature falls below a threshold value, the fuel cell 76 is switched on.

A heat exchanger is provided in the housing for heat transfer. The inlet and outlet of the heat exchanger each form interfaces for water or glycol lines. The filling opening, for example, is suitable for connection. Alternatively, the lines can be broken open and provided with a T-piece. Water lines are connected to the heating circuit, for example of the passenger cabin and/or the battery and/or other components if necessary. The control system regulates the vehicle outlet temperature at the heat exchanger. If only signals for the inlet temperature are available, the heat loss value for the vehicle can be determined or estimated if necessary in order to take the path losses into account.

The fuel cell module 14 provides energy that is inexpensive, makes optimal use of the hydrogen and is low in complexity. Instead of combining a large fuel cell with a small battery as is common in today's fuel cell vehicles, the present invention takes the opposite approach. A small fuel cell that delivers up to 11 kilowatts of electrical power, for example, is installed in an electric vehicle with normal storage capacity. This approach not only reduces costs and the package, but also significantly reduces application effort. To improve the service life of the fuel cell, it can be operated stationary at three operating points, for example. Since the load points are charging points for the vehicle battery, this also helps with integration and incorporation into the vehicle. Example operating points are listed below:
1. low load point (close to idle) with an electrical output of 2.1 kW and a thermal output of 3.0 kW. This is used to heat the battery at low temperatures.
2. medium load point with an electrical output of 3.6 kW and a thermal output of 6.2 kW. This is useful, for example, for operating operational consumers in the vehicle, such as lights and fans.
3. high load point with an electrical output of 11.0 kW and a thermal output of 20.5 kW. Such a load point is particularly useful for additional consumers, for example when a cooling or air conditioning system is to be operated or a mobile office is operated.

There are various switch-on conditions. These include thermal switch-on conditions, when the vehicle is switched off, no charging current is flowing, the outside temperature is below 15° C. and the battery charge level allows charging, i.e. the battery is not already fully charged. Electrical switch-on conditions include when the vehicle is moving and the range according to the navigation device is not sufficient to reach the destination with the current battery charge level. Here too, the battery charge level must allow charging. In principle, operation makes sense when the temperature of the battery is below the optimal operating temperature of, for example, 15° C.

Retrofitting vehicles with an electric main drive is only advantageously necessary if the temperatures in the places where the vehicle is moved actually fall below the threshold of, for example, 15° C. Unlike heat pumps, fuel cells also work in cold weather, preventing the battery from freezing. The fuel cell module can have its own small battery for its own operation and the start-up phase.

In addition to supplying vehicles with heat and electrical energy, various special applications are possible without changing the fuel cell module 14. For example, a cooling system of refrigerated vehicles, the heating and power supply of mobile homes, caravans and boats can be supplied with the module 14, especially when the drive is switched off. In addition to mobile applications, the fuel cell module 14 can also be used in stationary applications, for example when camping or as an emergency power supply for agricultural machinery, construction machinery, for the fire service and in disaster control as a replacement for emergency power generators that run on climate-damaging fossil fuels.

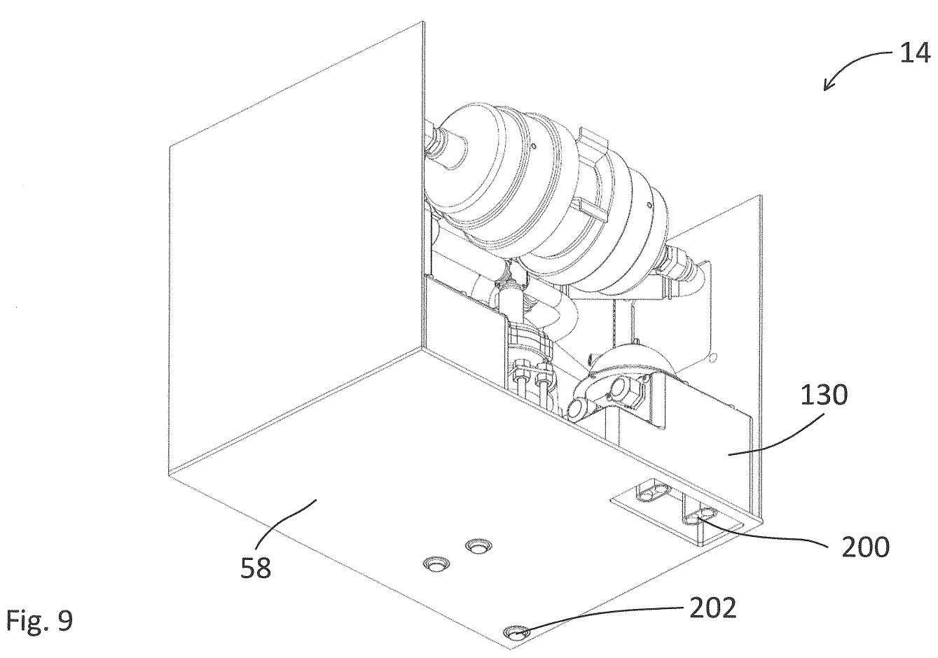

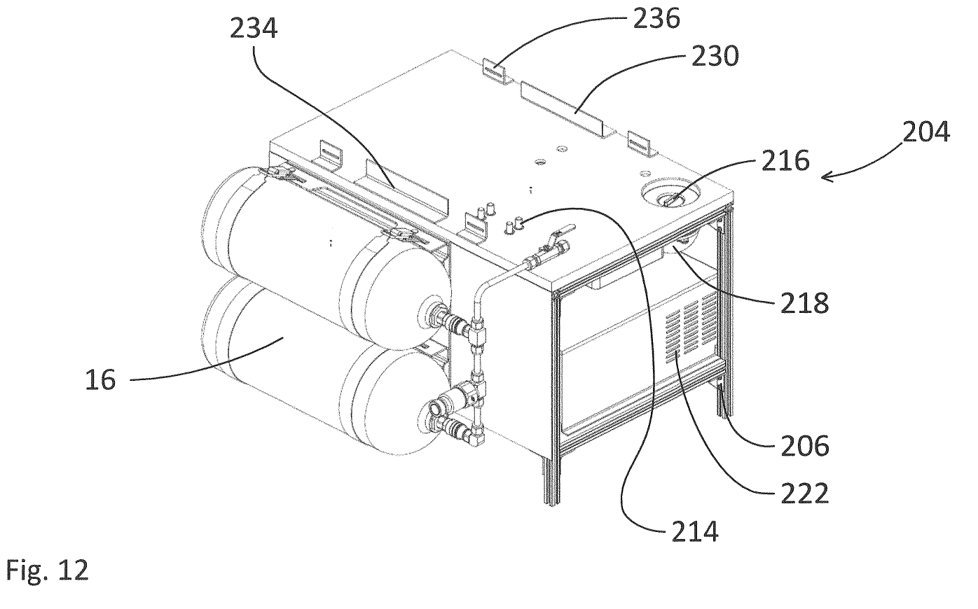

A second embodiment in which the fuel cell module 14 is used stationary is illustrated in FIGS. 9 to 13 and FIG. 18. Connections 200 for power transfer are provided in the base 58. The connections 200 are connected to an inverter 130 in the module 14, at which the electrical energy that can be tapped from the fuel cell 76 is converted into a desired voltage, for example 12, 24, 48, 230 or 400 volts. In addition, connections 202 are provided for connection to the water circuit.

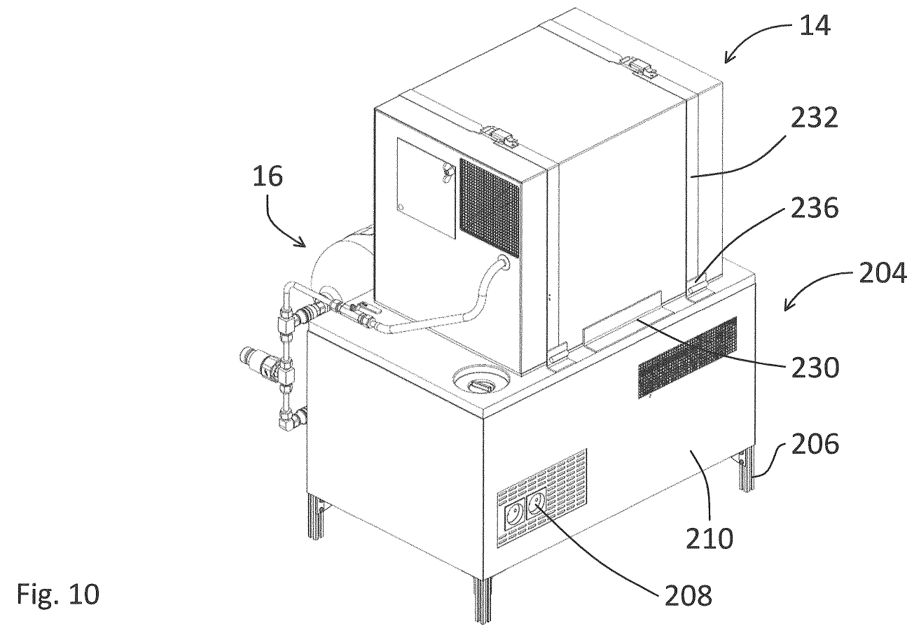

The fuel cell module 14 is placed on a base 204. This can be seen in FIG. 10. The base 204 has the external shape of a table with four legs 206. Power is provided at conventional sockets 208 on the front 210 of the base 204. The tank 16 can be attached to the panel on the back of the base 204 using the base plate 24.

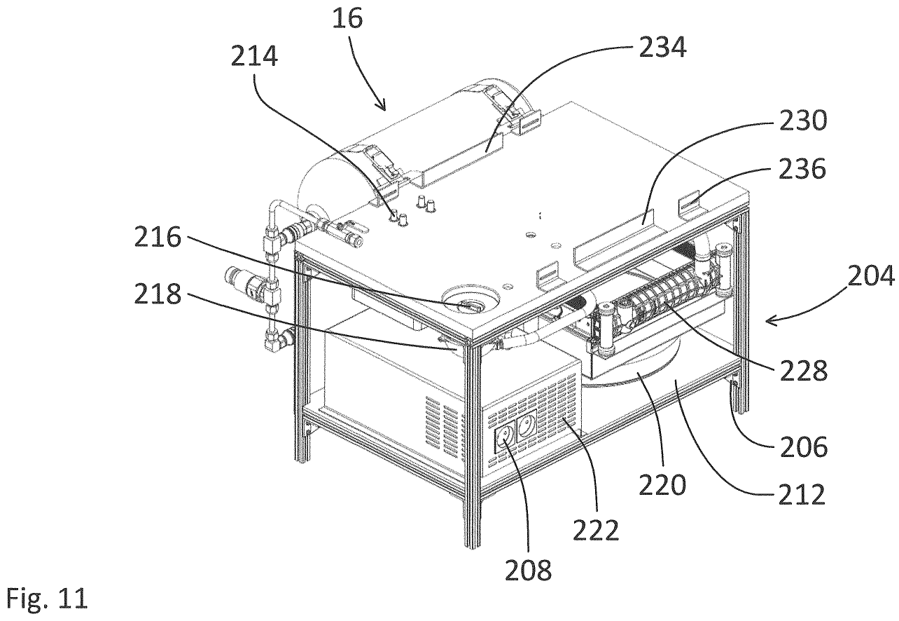

FIG. 11 shows the base 204 without the panel. The base 204 is provided with a floor 212 that is slightly above ground level. A conversion unit 222 is attached to the floor 212, which converts the voltage provided by the fuel cell module 14 into a voltage required by the consumer, for example an alternating voltage of 230 V or 400 V. The power is transferred to protruding connections 214 on the top of the base 204, which interact with the connections 200 on the underside of the module 14.

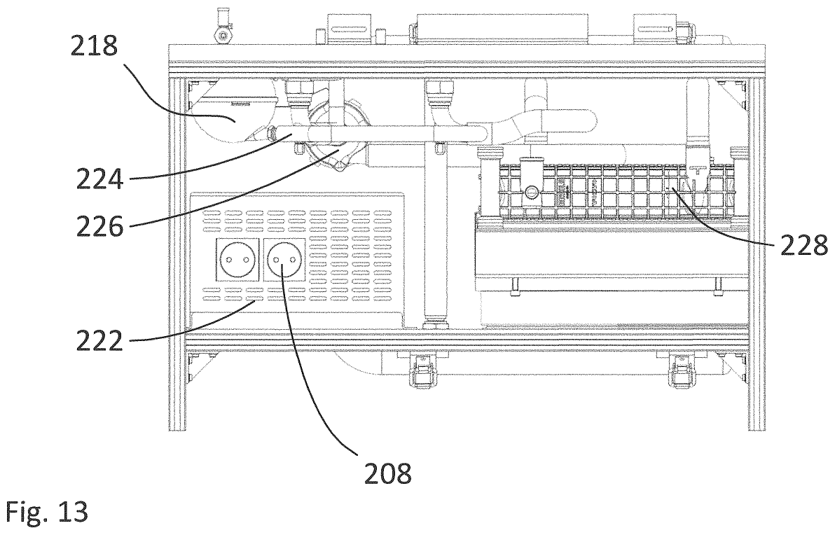

A refill nozzle 216 for cooling water on the base 204, which can be closed with a screw cap, enables the cooling circuit 224 and expansion tank 218 to be filled and refilled with coolant. The coolant pump 226 can be seen in FIG. 13.

A fan 220 is also arranged on the base 212. The fan 220 is used to dissipate heat to the outside in the area below the base 212. A capacitor 228 is arranged above the fan 220. This can be clearly seen in FIGS. 11 and 13.

If the fuel cell module 14 is to be used stationary, for example to provide emergency power, it is placed on the base 204 between two brackets 230 and 234 (FIG. 11) and can be held and secured there with straps 232 on fastening brackets 236. This is illustrated in FIG. 10.

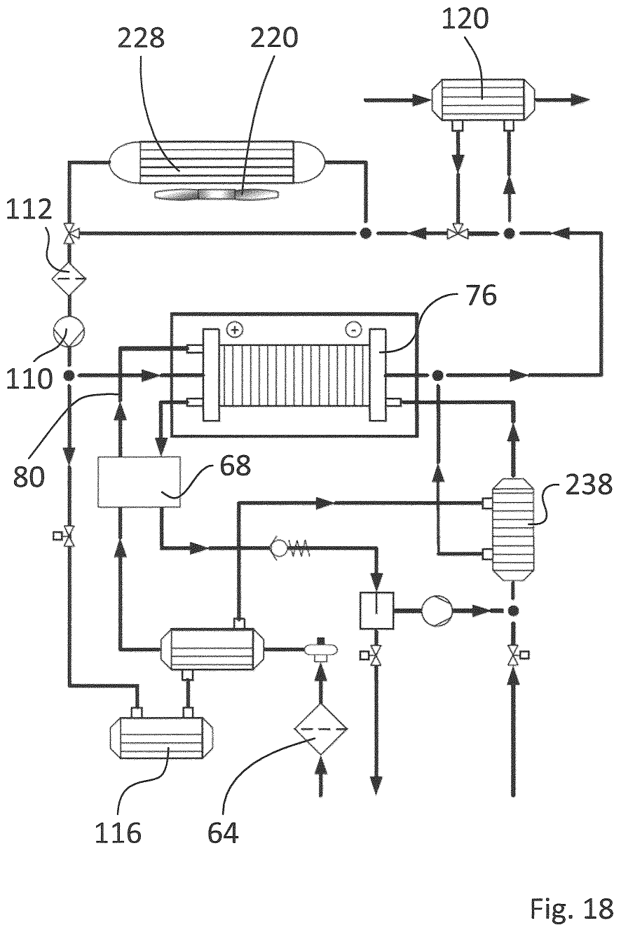

The stationary use with the base 204 works as illustrated in FIG. 18: In addition to the components already described in FIG. 14, a heat exchanger 238 for the fuel and the condenser 228 with fan 220 are integrated into the cooling circuit. These are located in the base 204.

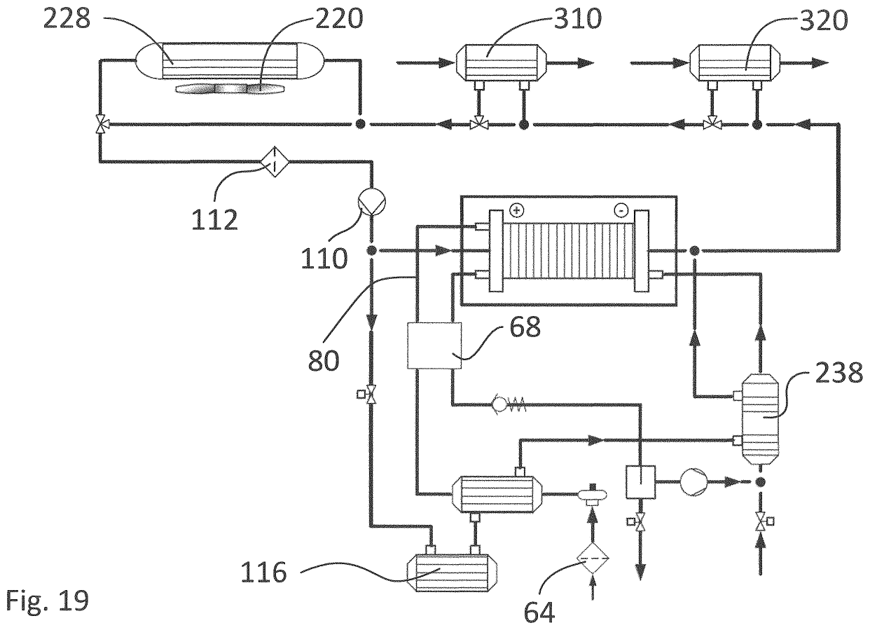

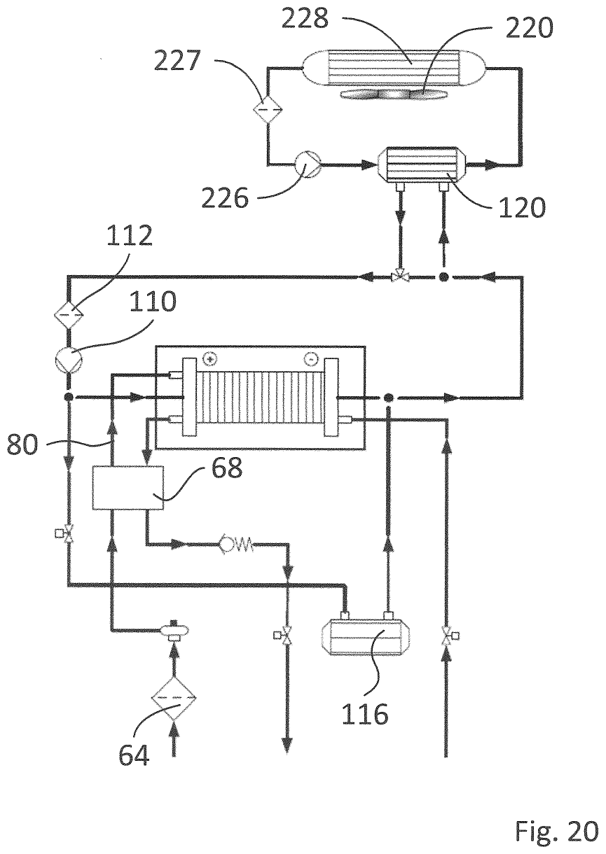

FIG. 19 is a further variant of FIG. 14 with two separate heat exchangers for e.g. a battery and the cabin 320. FIG. 20 shows circuits for the stationary application of the assembly from FIG. 10. A filter 227 can optionally be arranged in front of the pump.

The exemplary embodiments explained above serve to illustrate the invention claimed in the claims. Features that are disclosed together with other features can generally also be used alone or in combination with other features that are explicitly or implicitly disclosed in the text or drawings in the exemplary embodiments. Dimensions and sizes are given as examples only. Suitable ranges can be derived by the knowledge of the person skilled in the art and therefore do not need to be explained in more detail here. The disclosure of a specific embodiment of a feature does not mean that the invention should be limited to this specific embodiment. Rather, such a feature can be implemented using a variety of other configurations that are familiar to those skilled in the art. The invention can, therefore, be embodied not only in the form of the embodiments explained, but also in all embodiments which are covered by the scope of the appended claims.

The terms “top”, “bottom”, “right” and “left” exclusively refer to the attached drawings. It is understood that claimed devices also can adopt a different orientation. The term “including” and the term “comprising” mean that further components not mentioned may be provided. The terms “essentially” and “predominantly” include all characteristics that have a majority of a property or content, i.e. more than all the other components or properties of the feature mentioned, i.e. in the case of two components, for example, more than 50%.

1. Electrically operated vehicle comprising
(a) an electrically rechargeable vehicle battery for powering an electrical drive for moving the vehicle;
(b) a tank for storing liquid or gaseous fuel; and
(c) a fuel cell operated with fuel from said tank for heating the passenger cabin, vehicle components and/or vehicle battery of said vehicle;
characterized in that
(d) the tank and the fuel cell form modules with which the vehicle is retrofitted.

2. Vehicle according to claim 1, characterized in that the tank forms a separate module and is releasably accommodated in the vehicle or in the module.

3. Vehicle according to claim 2, characterized in that the fuel cell is connected to the vehicle battery and in operation electrical energy can be fed to the vehicle battery.

4. Vehicle according to claim 3, characterized in that the fuel tank is a hydrogen tank and the fuel cell is operated with hydrogen.

5. Vehicle according to claim 4, characterized in that a control unit is provided for controlling the fuel cell which operates the fuel cell at least partially depending on a temperature value.

6. Method for operating a fuel cell with the steps:
(a) determining a temperature value;
(b) regulating the temperature value by generating thermal energy with the fuel cell to a set value; wherein
(c) electrical energy which is generated during operation of the fuel cell is stored or used for an electrical consumer.

7. Method according to claim 6, characterized in that the temperature value represents the temperature in the passenger cabin of a vehicle, downstream of the vehicle heating or a vehicle battery.

8. Method according to claim 6, characterized in that the electrical energy is stored in a vehicle battery which is provided for driving a vehicle.

9. Method according to claim 8, characterized in that the electrical energy is at least partially fed into the on-board network of a vehicle with one or more electrical consumers.

10. Method according to claim 9, characterized in that at least one electrical consumer is a cooling unit.

11. Method according to claim 8, characterized in that the charge state of the battery is determined.

12. Method according to claim 11, characterized in that the fuel cell is only operated if the battery is in a charge state that allows further charging.

13. Method according to claim 12, characterized by the steps:
(a) determining a distance to a destination
(b) determining the power required for the distance from consumption and charge state of the vehicle battery;
(c) adjusting the load point to the required power.

14. Auxiliary unit for retrofitting a vehicle with an additional energy source, containing
(a) a tank for storing a liquid or gaseous fuel;
(b) a fuel cell for generating thermal and electrical energy;
(c) a control unit for controlling the operation of the fuel cell depending on a temperature and/or the charge state of the battery.

15. Auxiliary unit according to claim 14, characterized in that the tank, the fuel cell and the control unit are arranged in a jointly mountable module which has interfaces where the module can be connected to the respective functional units of the vehicle.
